(19) United States
(12) Patent Application Publication
(10) Pub. No.: US 2025/0140438 A1
(43) Pub. Date: May 1, 2025

(54) INSULATING COATING MATERIAL FOR COATING ELECTRIC WIRE, INSULATED WIRE, COIL, AND ELECTRIC OR ELECTRONIC DEVICE

(71) Applicant: Shin-Etsu Chemical Co., Ltd., Tokyo (JP)

(72) Inventors: Yoshihiro TSUTSUMI, Annaka-shi (JP); Tadaharu IKEDA, Annaka-shi (JP); Masayuki IWASAKI, Annaka-shi (JP)

(73) Assignee: Shin-Etsu Chemical Co., Ltd., Tokyo (JP)

(21) Appl. No.: 18/929,741

(22) Filed: Oct. 29, 2024

(30) Foreign Application Priority Data
Oct. 30, 2023 (JP) 2023-185398

(51) Int. Cl. H01B 3/30

(52) U.S. Cl. CPC H01B 3/306

(57) ABSTRACT

Provided are an insulating coating material for coating electric wire, which is capable of being cured at a relatively low temperature without using a high-boiling point solvent such as N-methyl-2-pyrrolidone (NMP), and provides a cured product that is excellent in balance between heat resistance, moisture resistance, insulation property, and flexibility; and an insulated wire or the like using the same. The insulating coating material for coating electric wire includes (A) a maleimide compound having a bisphenol structure and a number average molecular weight of 5,000 to 50,000, and (B) a reaction initiator. The insulated wire includes a cured film formed of the insulating coating material for coating electric wire.

### BACKGROUND OF THE INVENTION

### Field of the Invention

The present invention relates to an insulating coating material for coating electric wire, an insulated wire using the coating material, a coil using the insulated wire, and an electric or electronic device having the coil.

### Background Art

Heretofore, insulated wires having insulating films formed of polyamide-imide or polyimide resin insulating coating material (see JP-A-2013-1872, JP-A-2017-4897, JP-A-2017-130405, and JP-B-7257558) have been known. There are also known films, referred to as enamel layer, whose materials are made of heat-resistant polymer resins that are excellent in heat resistance, mechanical characteristics and hydrolysis resistance, etc.

Such coating material generally uses N-methyl-2-pyrrolidon (NMP) as a solvent. While NMP has long been used as an aprotic polar solvent in numerous situations, a stricter restriction is now imposed on the usage thereof mostly and particularly in Europe as the solvent has a high boiling point, tends to be readily exposed, and is toxic.

Further, the polyamide-imide and polyimide resin insulating coating materials are characterized by their tendency to absorb moisture easily. This not only causes problems such as the surface of the liquid turning white or the resin components precipitating or sedimenting due to the effects of humidity, but a variety of such materials also requires processing at extremely high temperatures such as 260° C. It is therefore considered that improvements from the perspective of environmental impact are also needed.

Moreover, the polyamide-imide and polyimide resin insulating coating materials have a high dielectric constant originating from their frame structures and reaction residues at their ends, and their dielectric constants can also increase due to moisture absorption. Therefore, in order to improve performance, it is desired to reduce the dielectric constant or to make it stabilized in a manner less dependent on the environment.

Meanwhile, insulating coating materials using (bis) maleimide compounds having a similar structure to the polyamide-imide or polyimide resins have also been reported (see JP-A-2012-87246, JP-A-2013-139531, and WO-A-2014/181456) although these references are not intended to solve the above-mentioned objects.

However, maleimide compounds generally tend to have low molecular weight and are therefore very hard and brittle. As a result, they are not suitable for use as insulating coating materials for, for example, coils which require flexibility, and materials for improving flexibility, if added thereinto, lead to a decrease in insulating property and/or heat resistance.

As explained above, there is still a need for the development of materials that are less susceptible to the effects of moisture absorption, have a low dielectric constant, do not use high-boiling point solvents such as NMP, and yet have an excellent balance between heat resistance, insulating properties, flexibility, etc.

### SUMMARY OF THE INVENTION

Therefore, it is an object of the present invention to provide an insulating coating material for coating electric wire, which is capable of being cured at a relatively low temperature without using a high-boiling point solvent such as NMP, and is excellent in balance between heat resistance, moisture resistance, insulation property, and flexibility. It is also an object of the present invention to provide an insulated wire using the insulating coating material for coating electric wire, a coil using the insulated wire, and an electric or electronic device having this coil.

The inventors of the present invention diligently conducted a series of studies to solve the aforementioned problems, and have found out that the insulating coating material for coating electric wire as defined below could achieve the above objectives, and thus completed the invention.
<1> An insulating coating material for coating electric wire comprising:
   (A) a maleimide compound having a number average molecular weight of 5,000 to 50,000 and defined by the following formula (1):

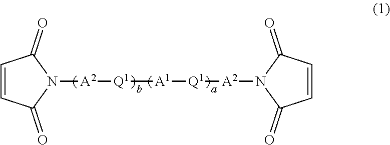

wherein, in the formula (1), each Q¹ independently represents a divalent group defined by the following formula:

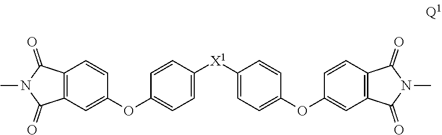

wherein X¹ independently represents a divalent group selected from any one of the following formulas:

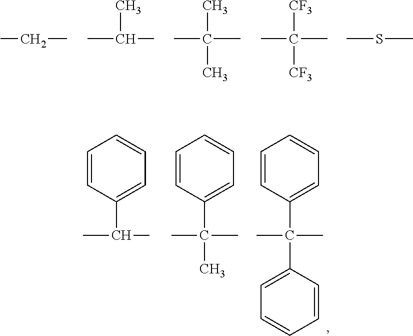

and
wherein, in the formula (1), a is a number of 0 to 50, b is a number of 1 to 50, and each of A¹ and A² independently represents a group defined by the formula (2) or (3):

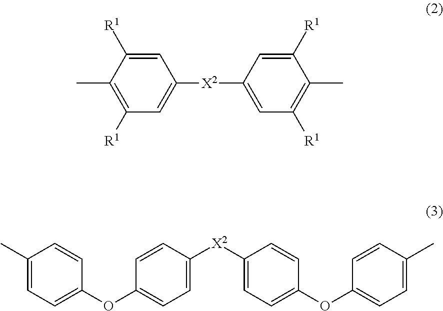

wherein, in the formulas (2) and (3), each X² independently represents a divalent group selected from any one of the following formulas:

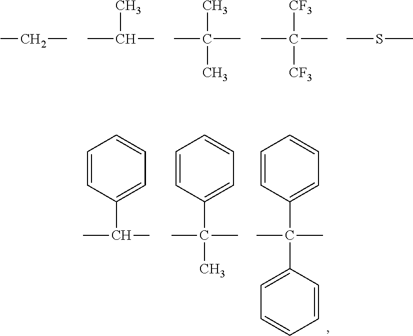

and
wherein, in the formula (2), each R¹ independently represents a hydrogen atom, a chlorine atom, or a substituted or unsubstituted aliphatic hydrocarbon group having 1 to 6 carbon atoms; and
(B) a reaction initiator.
<2> The insulating coating material according to <1>, wherein the reaction initiator (B) is an organic peroxide.
<3> The insulating coating material according to <2>, wherein the organic peroxide has an 1 hour half-life temperature of 110 to 150° C.
<4> The insulating coating material according to any one of <1> to <3>, further comprising (C) an organic solvent having a boiling point of 135 to 200° C.
<5> An insulated wire comprising:
   a conductor; and
   a cured film formed of the insulating coating material according to any one of <1> to <4>,
   wherein the cured film is directly formed on a surface of the conductor, or
   wherein the cured film is formed on a coating layer of the conductor, said conductor having the coating layer on a surface of the conductor.
<6> A coil comprising the insulated wire according to <5>.
<7> An electric or electronic device comprising the coil according to <6>.

The insulating coating material for coating electric wire according to the present invention is a material that is capable of being cured at a relatively low temperature without using a high-boiling solvent such as NMP, and provides a cured product that is excellent in balance between heat resistance, moisture resistance, insulation property, and flexibility. Further, this insulating coating material for coating electric wire is suitable for use in electric insulated wire, and the resultant electric insulated wire is helpful for use as a coil or an electric or electrical device.

### DETAILED DESCRIPTION OF THE INVENTION

Described hereunder are detailed embodiments of the present invention.

### (A) Maleimide Compound

The component (A) is a maleimide compound having a number average molecular weight of 5,000 to 50,000 and defined by the following formula (1):

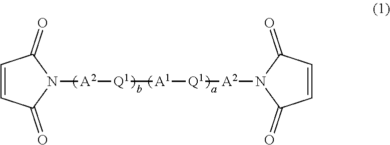

wherein, in the formula (1), Q¹ independently represents a divalent group defined by the following formula:

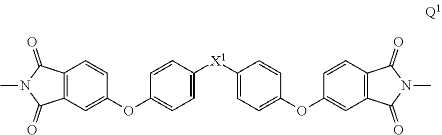

wherein X¹ independently represents a divalent group selected from any one of the following formulas:

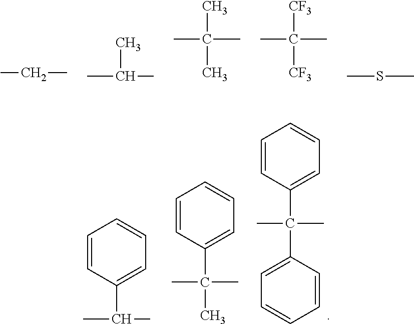

Further, the symbol “a” is a number of 0 to 50, “b” is a number of 1 to 50, and each of A¹ and A² independently represents a group defined by the formula (2) or (3):

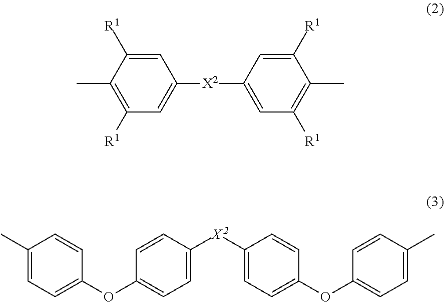

wherein, in the formulas (2) and (3), each X² independently represents a divalent group selected from any one of the following formulas:

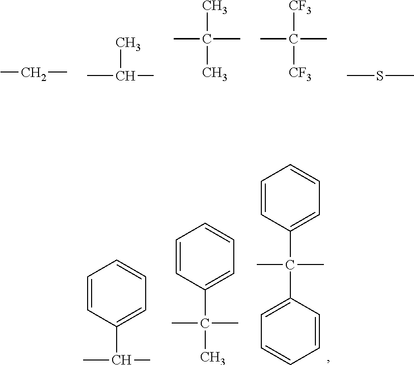

and each R¹ in the formula (2) independently represents a hydrogen atom, a chlorine atom, or a substituted or unsubstituted aliphatic hydrocarbon group having 1 to 6 carbon atoms.

In terms of raw material availability, —CH₂— or —C(CH₃)₂— is preferred as X¹ that is defined in the formula (1).

In the formula (1), the symbol “a” represents a number of 0 to 50, preferably 1 to 40.

In the formula (1), the symbol “b” represents a number of 1 to 50, preferably 1 to 40. In the formula (1), the sum of “a” and “b” is not limited as long as it satisfies the number average molecular weight described below, but is preferably less than 30, more preferably 25 or less, and even more preferably 20 or less.

In the formula (1), each of A¹ and A² independently represents a group defined by the formula (2) or (3).

In terms of raw material availability, —CH₂— or —C(CH₃)₂— is preferred as X² that is defined in the formulas (2) and (3).

In the formula (2), R¹ independently represents a hydrogen atom, a chlorine atom, or a substituted or unsubstituted aliphatic hydrocarbon group having 1 to 6 carbon atoms.

Examples of the substituted or unsubstituted aliphatic hydrocarbon group having 1 to 6 carbon atoms represented by R¹ in the formula (2) include a methyl group, an ethyl group, an n-propyl group, an isopropyl group, an n-butyl group, a t-butyl group and a cyclohexyl group; as well as groups obtained by substituting a part of or all the hydrogen atoms in any of these groups with halogen atoms such as F, Cl and Br, and an example of which being a trifluoromethyl group. It is preferred in terms of raw material availability that R¹ be a hydrogen atom or a substituted or unsubstituted aliphatic hydrocarbon group having 1 to 3 carbon atoms.

Further, in the maleimide compound defined by the formula (1), it is preferred that A¹ and A² be groups that differ from each other. For example, in the formula (1), it is preferred that A² be a group defined by the formula (3) when A¹ is a group defined by the formula (2), or that A² be a group defined by the formula (2) when A¹ is a group defined by the formula (3). Here, the maleimide compound as defined by the formula (1) is not a compound wherein A¹ and A² simultaneously satisfy the formula (2).

A bonding pattern of the repeating units with the repetition numbers a and b in the maleimide compound as defined by the formula (1) may be block or random. However, in terms of the mechanical strength of the cured product, a block bonding pattern is preferred.

As shown in the formula (1), the component (A) has a bisphenol structure in one molecule, is soluble in solvents other than NMP, and is excellent in solubility into solvents. A maleimide compound having a bisphenol structure is also preferred in terms of raw material availability. Examples of such bisphenol structure contained in the component (A) include bisphenol A, bisphenol F, bisphenol E, and bisphenol AF among which, although not limited to the followings, bisphenol A and bisphenol F are preferred. The maleimide compound defined by the formula (1) is a compound having the above-defined ranges of a and b, which allows a favorable balance between solubility in a solvent and film-forming ability when uncured, and the toughness and heat resistance of the resultant cured product.

The number average molecular weight of the maleimide compound as the component (A) is 5,000 to 50,000, preferably 7,000 to 40,000, more preferably 8,000 to 20,000. The number average molecular weights within these ranges allow the maleimide compound as the component (A) to be stably solubilized into solvents, ensure wettability to a base material, and make un-cured film less likely to, for example, crack, thus resulting in a favorable film.

Here, the number average molecular weight as used herein refers to a number average molecular weight that is measured by gel permeation chromatography (GPC) under the following conditions, using polystyrene as a reference substance.

### [GPC Measurement Conditions]

Developing solvent: Tetrahydrofuran (THF)
Flow rate: 0.35 mL/min
Detector: Differential refractive index detector (RI)
Column: TSK-gel H type (manufactured by Tosoh Corporation
Column temperature: 40° C.
Sample injection volume: 5 μL (THF solution with a concentration of 0.2% by mass)

The maleimide compound as the component (A) defined by the formula (1) can be produced using a method that is described in, for example, JP-A-2021-017485.

The maleimide compound as the component (A) may be used alone, or two or more of them may be used in combination.

Further, in the curable maleimide resin composition of the present invention, the component (A) is preferably contained in an amount of 70 to 99.9% by mass, more preferably 80 to 99.5% by mass, even more preferably 85 to 99.0% by mass (if the composition contains (C) an organic solvent to be explained below, it refers to the content of the component (A) in the composition excluding the organic solvent (C)).

### (B) Reaction Initiator

A reaction initiator as a component (B) is added to initiate and promote a cross-linking reaction of the maleimide compound as the component (A), and a reaction between the maleimide groups in the component (A) and reactive groups capable of reacting with them.

Although there are no particular restrictions on the component (B) so long as it is capable of promoting the cross-linking reaction, it is preferred that the component (B) be an organic peroxide as a thermal radical polymerization initiator that can make it easily cured in a short period of time for improving productivity.

Typical examples of such organic peroxide include dicumyl peroxide, t-butyl peroxybenzoate, t-amyl peroxybenzoate, dibenzoyl peroxide, dilauroyl peroxide, 2,5-dimethyl-2,5-di(t-butylperoxy)hexane, 1,1-di(t-butylperoxy)cyclohexane, di-t-butyl peroxide, dibenzoyl peroxide, and 1,6-bis(t-butylperoxycarbonyloxy)hexane.

Of these, it is preferred that the organic peroxide have a 1 hour half-life temperature of 110 to 150° C. An organic peroxide having a 1 hour half-life temperature of 110° C. or more prevents itself from being removed together with the organic solvent in the step of removing the organic solvent, and prevents the curing reaction from proceeding too quickly and being cured in a state in which the organic solvent still remains, and therefore desired properties will easily be obtained. The 1 hour half-life temperature of 150° C. or less also allows the resin to be cured within a short period of time without necessarily having to raise the curing temperature.

It is preferred that the reaction initiator be added in an amount of 0.05 to 10 parts by mass, more preferably 0.1 to 5 parts by mass, per 100 parts by mass of the component (A). Further, if adding the later-described further heat-curable resin to the composition, it is preferred that the reaction initiator be added in an amount within the range of 0.05 to 10 parts by mass, particularly preferably 0.1 to 5 parts by mass, per a total of 100 parts by mass of the component (A) and the further heat-curable resin component. The amount of the reaction initiator within the range of 0.05 to 10 parts by mass per 100 parts by mass of the component (A) will not lead to a curing that is extremely slow or fast during the forming. Further, the obtained cured product exhibits a favorable balance between heat resistance and moisture resistance.

One kind of such reaction initiator may be used alone, or two or more kinds thereof may be used in combination.

The composition of the present invention may contain the following.

### (C) Organic Solvent

The insulating coating material for coating electric wire according to the present invention may optionally contain an organic solvent as the component (C). Any type of organic solvent may be used so long as it is capable of dissolving the component (A) but an organic solvent having a boiling point of 135 to 200° C. is typically used. An organic solvent having a boiling point of this range leads to a favorable balance between ensuring workability and ease of removal of the organic solvent when the insulating coating material for coating electric wire is used (after application of the insulating coating material for coating electric wire). Further, the insulating coating material for coating electric wire can be regarded as a material that is environmentally friendly because this material does not use NMP as explained above.

Here, the expression “the component (C) is capable of dissolving the component (A)” refers to a condition in which one cannot visually recognize any undissolved residues of the component (A) at 25° C. when a solution of 25% by mass of the component (A) with the component (C) as the solvent was prepared. An organic solvent to be added thereinto can be suitably used to perform coating.

There may be used general organic solvents as the component (C) such as, for example, xylene, mesitylene, anisole, cyclohexanone, cyclopentanone, dimethylsulfoxide (DMSO), and dimethylacetamide. Any one of these organic solvents may be used alone, or two or more of them may be used in combination.

Of these, preferable examples of the organic solvent for the component (C) in the insulating coating material for coating electric wire are cyclohexanone, xylene and anisole.

The amount of the component (C) added is practically controlled in accordance with the desired viscosity for the process, and it is generally preferred that the amount of the component (C) be 100 to 1,000 parts by mass, more preferably 150 to 800 parts by mass per 100 parts by mass of the component (A).

### Further Additive

Various additives may be added to the insulating coating material for coating electric wire of the present invention, provided that the advantageous effects of the present invention are not impaired. For example, in order to improve resin properties, there may be added a heat-curable resin such as an acrylic resin; an organopolysiloxane; a silicone oil; a thermoplastic resin; a thermoplastic elastomer; an organic synthetic rubber; a light stabilizer; a polymerization inhibitor; a flame retardant; a pigment; and a dye. There may also be added an adhesion aid of, for example, a silane coupling agent to enhance the adhesivity to the electric wire of, for example, copper. A compound having a diamino triazine ring or a benzotriazole analog is particularly preferred for enhancing adhesivity to copper. Meanwhile, silane coupling agents are often effective, but depending on the curing system, they may not be incorporated into the crosslinking, and the relative dielectric constant tends to increase due to residual epoxy groups, so their use is not very preferred.

Further, in order to improve electric properties, there may be added, for example, an ion trapping agent. Furthermore, in order to improve dielectric properties, there may be added, for example, a fluorine-containing material. An inorganic filler such as silica may also be added for the purpose of adjusting a coefficient of thermal expansion (CTE). Nevertheless, it is often the case that the addition of these ingredients is not preferable depending on the film-forming method, thickness, and/or appearance of the coating.

The insulating coating material for coating electric wire according to the present invention may be produced by mixing the components (A), (B), and (C) as well as the further additive. The insulating coating material for coating electric wire according to the present invention may be used for an insulated wire, a coil using the wire, and an electric or electronic device having this coil.

Examples of use are given below, but are not limited to these.

For example, in general, a method that is usually used for forming an insulating film on an electric wire may be suitably used for producing the insulated wire.

The insulating coating material for coating electric wire of the present invention may be directly applied to the surface of a conductor and baked, so that a cured film (enamel layer) of the insulating coating material is directly formed on the surface of the conductor, or otherwise, the insulating coating material for coating electric wire of the present invention may be applied to a coating layer of a conductor having the coating layer on its surface and baked, so that a cured film (enamel layer) of the insulating coating material is formed on the coating layer of the conductor. The coating layer of the conductor is different from the cured film of the insulating coating material, and an example of which include a layer formed by coating the conductor with, for example, polyimide, polyamideimide or polyetherimide. An extrusion layer may be formed as well by extrusion coating. After the coating, it may be heated for 0.1 to 5 hours at a temperature of usually 80° C. or higher, preferably 100° C. or higher to remove the organic solvent. Furthermore, if the resin is of a thermosetting type, an electric wire coated with the coating material of the present invention may be heated for 0.5 to 10 hours at a temperature of 130° C. or higher, preferably 150° C. or higher to form a strong coating with a flat surface.

Polyimides generally require a temperature of 150° C. or higher for drying, and a temperature of 220° C. or higher for thermal curing. Nevertheless, the insulating coating material for coating electric wire according to the present invention does not require such high-temperature conditions. Specifically, removal of the organic resin may be performed at 150° C. or lower, and thermal curing (film formation) may be performed at 200° C. or lower.

### WORKING EXAMPLES

The present invention is described in detail hereunder with reference to working and comparative examples. However, the present invention shall not be limited to the following Working Examples. In the working and comparative examples, the term “room temperature” means 25° C.

The components used in the working and comparative examples will be explained below. A number average molecular weight (Mn) mentioned hereunder is a value obtained by gel permeation chromatography (GPC) that is measured under the following measurement conditions using polystyrene as a reference material.

### [GPC Measurement Condition]

Developing solvent: Tetrahydrofuran
Flow rate: 0.35 mL/min
Detector: Differential refractive index detector (RI)
Column: TSK-gel H type (manufactured by TOSOH CORPORATION)
Column temperature: 40° C.
Sample injection volume: 5 μL (THF solution with a concentration of 0.2% by mass)

### (A) Maleimide Compound

### Synthesis Example 1

Here, 65.06 g (0.125 mol) of 2,2-bis[4-(2,3-dicarboxyphenoxy)phenyl] propane dianhydride, 61.59 g (0.150 mol) of 2,2-bis[4-(4-aminophenoxy)phenyl]propane, and 250 g of anisole were added to a 1 L glass four-necked flask equipped with a stirrer, a Dean-Stark tube, a cooling condenser and a thermometer, followed by stirring them at 80° C. for three hours to synthesize an amic acid. Next, the temperature was directly raised to 150° C., where stirring was performed for another 2 hours while distilling away water generated as a by-product, thereby producing a diamine compound with each end being blocked with an amino group (this type of diamine compound is also referred to simply as “diamine compound” hereunder).

After cooling the flask containing the resultant diamine compound solution to room temperature, 4.39 g (0.055 mol) of maleic anhydride was added thereto, followed by performing stirring at 80° C. for three hours to synthesize a maleamic acid. Then, the temperature was directly raised to 150° C., where stirring was performed for 2 hours while distilling away water generated as a by-product, thereby obtaining a varnish of aromatic bismaleimide compound defined by the formula (A-1) as shown below:

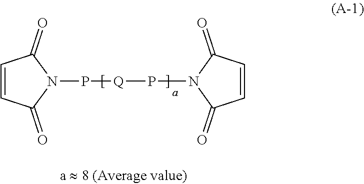

wherein, in the formula (A-1), P and Q respectively and independently represent divalent groups defined by the following formulas:

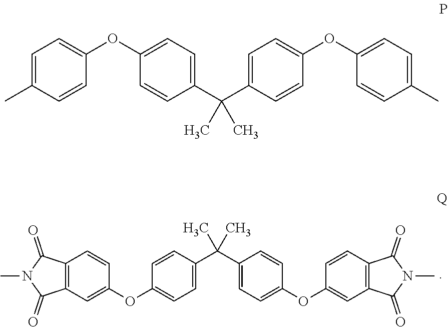

The aromatic bismaleimide compound had a number average molecular weight (Mn) of 12,000. Anisole was then added to the varnish in a way such that non-volatile constituents of the vanish would be in an amount of 25% by mass

### Synthesis Example 2

Here, 65.06 g (0.125 mol) of 2,2-bis[4-(2,3-dicarboxyphenoxy)phenyl] propane dianhydride, 35.26 g (0.115 mol) of 4,4′-methylenebis(2,6-diethylaniline), and 250 g of anisole were added to a 1 L glass four-necked flask equipped with a stirrer, a Dean-Stark tube, a cooling condenser and a thermometer, followed by stirring them at 80° C. for three hours to synthesize an amic acid. Next, the temperature was directly raised to 150° C., where stirring was performed for 2 hours while distilling away water generated as a by-product, thereby synthesizing a copolymer.

Then, 7.05 g (0.015 mol) of 2,2-bis[4-(4-aminophenoxy)phenyl]propane was added to the flask containing the copolymer solution cooled to room temperature, followed by performing stirring at 80° C. for three hours to synthesize an amic acid. After that, the temperature was directly raised to 150° C., where stirring was performed for 2 hours while distilling away water generated as a by-product, thereby synthesizing a diamine compound.

After cooling the flask containing the resultant diamine compound solution to room temperature, 1.45 g (0.015 mol) of maleic anhydride was added thereto, followed by performing stirring at 80° C. for three hours to synthesize a maleamic acid. Then, the temperature was directly raised to 150° C., where stirring was performed for 2 hours while distilling away water generated as a by-product, thereby obtaining a varnish of aromatic bismaleimide compound defined by the formula (A-2) as shown below:

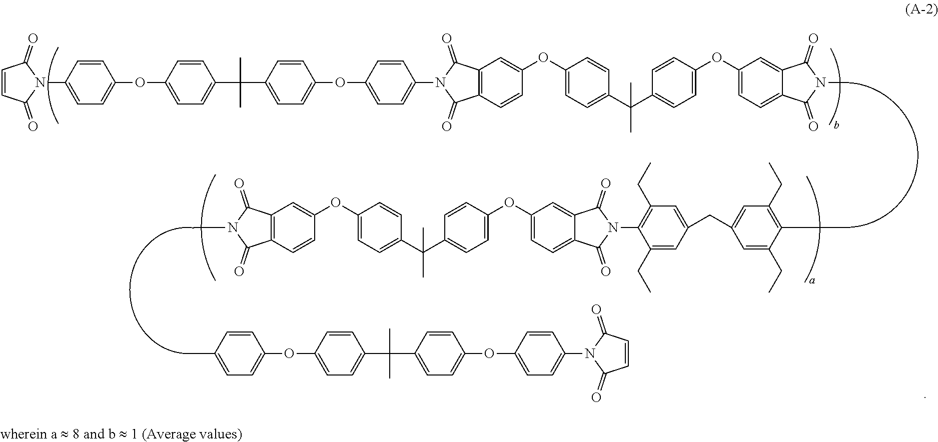

The aromatic bismaleimide compound had a number average molecular weight (Mn) of 15,500. Anisole was then added to the varnish in a way such that non-volatile constituents of the varnish would be in an amount of 25% by mass.

### Other Maleimide Compound

(A-3): Bismaleimide compound represented by the following formula (Trade name: BMI-5000; Mn: 8,000; manufactured by Designer Molecules Inc.)

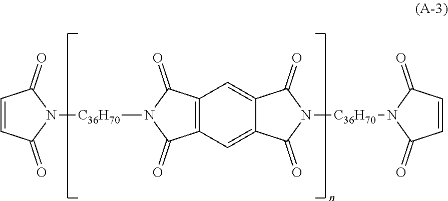

wherein —C₃₆H₇₀— represents a dimer acid frame-derived hydrocarbon group, and n≈8 (Average value).
(A-4): 4,4′-diphenylmethane bismaleimide (BMI-1000, Mn: 410, manufactured by Daiwa Kasei Industry Co., Ltd.)
(A-5): Bisphenol A diphenyl ether bismaleimide (BMI-4000, Mn: 571, manufactured by Daiwa Kasei Industry Co., Ltd

### Synthesis Example 3

Here, 77.55 g (0.149 mol) of 2,2-bis[4-(2,3-dicarboxyphenoxy)phenyl] propane dianhydride, 61.59 g (0.150 mol) of 2,2-bis[4-(4-aminophenoxy)phenyl]propane, and 250 g of anisole were added to a 1 L glass four-necked flask equipped with a stirrer, a Dean-Stark tube, a cooling condenser and a thermometer, followed by stirring them at 80° C. for three hours to synthesize an amic acid. Then, the temperature was directly raised to 150° C., where stirring was performed for 2 hours while distilling away water generated as a by-product, thereby producing a diamine compound.

After cooling the flask containing the resultant diamine compound solution to room temperature, 0.79 g (0.010 mol) of maleic anhydride was added thereto, followed by performing stirring at 80° C. for three hours to synthesize a maleamic acid. Then, the temperature was directly raised to 150° C., where stirring was performed for 2 hours while distilling away water generated as a by-product to obtain a varnish of aromatic bismaleimide compound defined by the formula (A-6) as shown below:

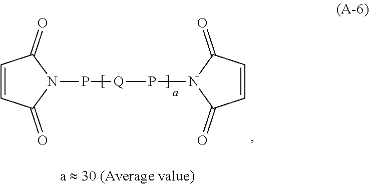

wherein, in the formula (A-6), P and Q respectively and independently represent divalent groups defined by the following formulas:

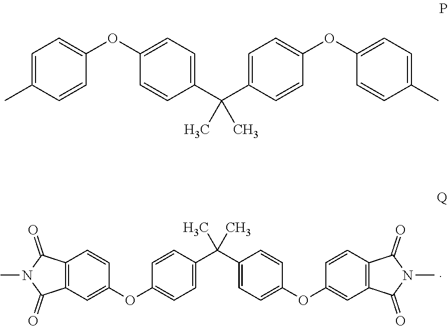

It, however, turned out that this varnish had an excessively high viscosity at room temperature, and was in a state in which the stirring could not be performed. The aromatic bismaleimide compound had a number average molecular weight (Mn) of 72,000, and was extremely difficult to handle. For this reason, it was determined not to use this bismaleimide for evaluation.

### (B) Reaction Initiator

(B-1): Dicumylperoxide (Tradename: Perkadox BC-FF; manufactured by KAYAKU NOURYON CORPORATION; 1 hour half-life temperature of 132° C.)
(C-1): Anisole (Manufactured by Tsujimoto Chemical Co., Ltd.)

### Materials Used for Comparative Examples

A polyamic acid varnish (KJR-655 manufactured by Shin-Etsu Chemical Co., Ltd.; NMP-containing varnish; non-volatile content of 15% by mass) was directly used.

A polyamide imide varnish (VYLOMAX HR-11NN manufactured by TOYOBO CO., LTD; NMP-containing varnish; non-volatile content of 15% by mass) was directly used.

### Working Examples 1 to 3, Comparative Examples 1 to 8

### Solubility

Respective components were mixed at the formulations as shown in Table 1 (with the content of 25% by mass of the component (A)), except for the polyamic acid varnish and polyamide imide varnish that are materials used for comparative examples, to prepare resin coating materials. Here, the materials in which the component (A) has completely dissolved were indicated as “Dissolved” in the table while the materials in which the component (A) remained not completely dissolved at the time of mixing or those that exhibited precipitation after leaving them for 12 hours at 25° C. were indicated as “Undissolved”. No further evaluation was made at this point for those indicated as “Undissolved”

### Coating Material Stability Test

Coating materials were respectively put on pans of aluminum and stored for 60 minutes in a constant temperature and humidity bath at 30° C. and 60% RH. Then, the surfaces of the respective coating materials were visually confirmed. The coating materials that underwent no noticeable changes, were transparent and exhibited no resin precipitations were indicated as “Stable”, while those in which the coating materials became hardened or whitened were indicated as “Unstable”.

### Production of Test Strip

Using a roller coater, each of the coating materials was applied to a mold release-treated PET film (Trade name: TN-010, manufactured by TOYOBO STC Co., Ltd.) in a manner such that a thickness of the material would eventually become 50 μm after drying, which then underwent drying under the respective conditions. Then, resin films were peeled off from the PET films to produce cured films while tensioning them using a jig under the respective conditions. Details of the respective drying and curing conditions are as shown below.

Note that the resin of the comparative example 8 did not cure under the curing condition A to be explained below, and therefore a film of the comparative example 8 cured under the following condition B was used for the following tests. The resin of the comparative example 7 resulted in a film under both of the conditions A and B, and therefore films obtained using both of the conditions were used to perform the following measurements.

Curing Condition A: Curing at 110° C. for 30 minutes+Curing at 180° C. for two hours

Curing Condition B: Curing at 150° C. for one hour+Curing at 200° C. for one hour+Curing

at 250° C. for four hours

Moreover, cured films were successfully produced from every coating material of the working examples 1 to 3, and these cured film had flexibility, which demonstrates that the coating materials of the present invention are suitable for use in coating materials having flexibility such as a coil, an electric wire or other coating subjects who have flexibility in themselves.

### Measurement of Relative Permittivity

Relative permittivities at 50 Hz of resin films prepared in manners as shown in the working and comparative examples (denoted as “Relative Permittivity (Initial)” in Table 1) were measured in accordance with JIS K6911:2006. This measurement was performed using the same procedure after storing this film for 24 hours in a constant temperature and humidity bath at 85° C. and 85% RH (denoted as “Relative Permittivity (Moisture absorption)” in Table 1). This measurement was also performed using the same procedure after storing the film, prepared independently of the above measurement, for 1,000 hours in a constant temperature bath at 150° C. (denoted as “Relative Permittivity (Heat treatment)” in Table 1).

### Measurement of Dielectric Breakdown Voltage

Dielectric breakdown voltages of resin films, prepared in manners as shown in the working and comparative examples, were measured in accordance with JIS C2110-1:2016.

TABLE 1

| Composition Compounding Table | | | Working Examples | | | Comparative Examples | | | | | | | | |
|---|---|---|---|---|---|---|---|---|---|---|---|---|---|---|
| (Parts by mass) | | | 1 | 2 | 3 | 1 | 2 | 3 | 4 | 5 | 6 | 7 | | 8 |
| (A) | A-1 | A-1 | 100.0 | | 50.0 | | | | | | | KJR-655 | | HR- |
| | A-2 | A-2 | | 100.0 | 50.0 | | | | | | | | | 11NN |
| | BMI-5000 | A-3 | | | | 100.0 | | | 50.0 | 50.0 | 80.0 | | | |
| | BMI-1000 | A-4 | | | | | 100.0 | | 50.0 | | | | | |
| | BMI-4000 | A-5 | | | | | | 100.0 | | 50.0 | 20.0 | | | |
| (B) | Perkadox BC-FF | B-1 | 2.0 | 2.0 | 2.0 | 2.0 | 2.0 | 2.0 | 2.0 | 2.0 | 2.0 | | | |
| (C) | Anisole | C-1 | 300.0 | 300.0 | 300.0 | 300.0 | 300.0 | 300.0 | 300.0 | 300.0 | 300.0 | | | |
| Evalu- | Solubility | | Dis- | Dis- | Dis- | Dis- | Undis- | Undis- | Undis- | Dis- | Dis- | Dis- | | Dis- |
| ation | | | solved | solved | solved | solved | solved | solved | solved | solved | solved | solved | | solved |
| Results | Coating Material | | Stable | Stable | Stable | Stable | — | — | — | Unstable | Stable | Unstable | | Unstable |
| | Stability | | | | | | | | | | | | | |
| | Curing Condition | | A | A | A | A | — | — | — | — | A | A | B | B |
| | Relative | | 2.4 | 2.5 | 2.4 | 2.5 | — | — | — | — | 2.7 | 3.2 | 3.0 | 4.0 |
| | Permittivity | | | | | | | | | | | | | |
| | (Initial) | | | | | | | | | | | | | |
| | Relative | | 2.5 | 2.6 | 2.5 | 2.5 | — | — | — | — | 3.4 | 4.0 | 3.6 | 4.9 |
| | Permittivity | | | | | | | | | | | | | |
| | (Moisture | | | | | | | | | | | | | |
| | Absorption) | | | | | | | | | | | | | |
| | Relative | | 2.3 | 2.4 | 2.4 | 2.9 | — | — | — | — | 3.2 | 3.2 | 3.0 | 4.0 |
| | Permittivity | | | | | | | | | | | | | |
| | (Heat Treatment) | | | | | | | | | | | | | |
| | Dielectric | kV/100 | 12.6 | 14.2 | 13.0 | 11.0 | — | — | — | — | 8.8 | 7.3 | 13.1 | 11.6 |
| | Breakdown | um | | | | | | | | | | | | |
| | Voltage | | | | | | | | | | | | | |

What is claimed is:

1. An insulating coating material for coating electric wire comprising:
(A) a maleimide compound having a number average molecular weight of 5,000 to 50,000 and defined by the following formula (1): 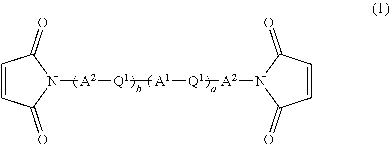
wherein, in the formula (1), each Q¹ independently represents a divalent group defined by the following formula: 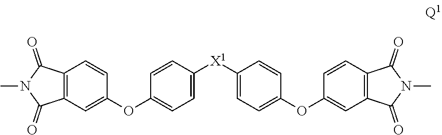
wherein X¹ independently represents a divalent group selected from any one of the following formulas: 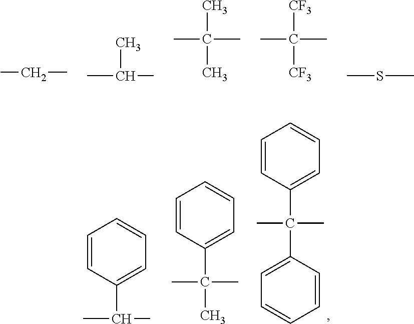
and
wherein, in the formula (1), a is a number of 0 to 50, b is a number of 1 to 50, and each of A¹ and A² independently represents a group defined by the formula (2) or (3): 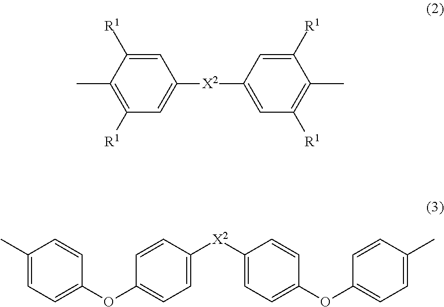
wherein, in the formulas (2) and (3), each X² independently represents a divalent group selected from any one of the following formulas: 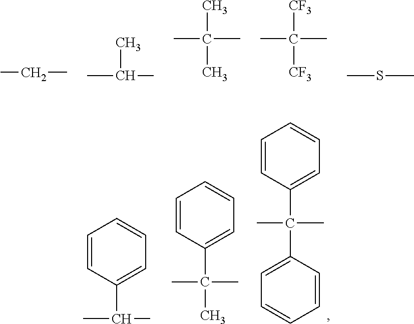
and
wherein, in the formula (2), each R¹ independently represents a hydrogen atom, a chlorine atom, or a substituted or unsubstituted aliphatic hydrocarbon group having 1 to 6 carbon atoms; and
(B) a reaction initiator.

2. The insulating coating material according to claim 1, wherein the reaction initiator (B) is an organic peroxide.

3. The insulating coating material according to claim 2, wherein the organic peroxide has an 1 hour half-life temperature of 110 to 150° C.

4. The insulating coating material according to claim 1, further comprising (C) an organic solvent having a boiling point of 135 to 200° C.

5. An insulated wire comprising:
a conductor; and
a cured film formed of the insulating coating material according to claim 1,
wherein the cured film is directly formed on a surface of the conductor, or
wherein the cured film is formed on a coating layer of the conductor, said conductor having the coating layer on a surface of the conductor.

6. A coil comprising the insulated wire according to claim 5.

7. An electric or electronic device comprising the coil according to claim 6.
